(19) United States
(12) Patent Application Publication
(10) Pub. No.: US 2009/0289929 A1
(43) Pub. Date: Nov. 26, 2009

(54) Plasma display device and driving method thereof

(76) Inventors: Seungyong LEE, Yongin-si (KR); Hakcheol YANG, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 12/453,545

(22) Filed: May 14, 2009

(30) Foreign Application Priority Data
May 20, 2008 (KR) 10-2008-0046530

(51) Int. Cl. G09G 5/00; G09G 3/28

(52) U.S. Cl. 345/211; 345/68

(57) ABSTRACT

A plasma display device includes a scan driver adapted to apply reset, scan and sustain signals to scan electrodes, a sustain driver adapted to apply a sustain signal to sustain electrodes, and a display panel including discharge cells and discharge spaces, wherein the discharge cells are partitioned by horizontal and vertical barrier ribs on the display panel, on adjacent ones of the discharge cells, corresponding ones of the scan and sustain electrodes are alternatively arranged in a scan-sustain-sustain-scan electrode or a sustain-scan-scan-sustain electrode manner, the discharge spaces are between the horizontal barrier ribs of two adjacent rows of the discharge cells, and adjacent ones of the scan electrodes are electrically connected in parallel and spaced apart from each other in a region above the respective discharge space.

### BACKGROUND

1. Field

Embodiments relate to a plasma display device and a driving method thereof. More particularly, embodiments relate to a plasma display device and a driving method thereof that may be adapted to more easily perform high-speed driving by reducing a time of an addressing period for selectively addressing discharge cells and/or improve image contrast by addressing each discharge cell using only an address discharge weaker than a conventional address discharge.

2. Description of the Related Art

A plasma display device displays an image using plasma discharge, and may realize digital images and more easily provide a relatively larger screen, as compared to other display devices.

In driving the plasma display device, one frame is divided into a plurality of sub-fields. Each sub-field is divided into a reset period, an address period and a sustain period. Driving waveforms are applied during the reset, address and sustain periods.

During the reset period, wall charge states of all discharge cells are driven to be equal to each other. Information of an image displayed just before the respective reset period is erased and, simultaneously, initial conditions of all the discharge cells are reset to be the same as each other. Thus, subsequent address discharge may occur under the same conditions.

During the address period, each discharge cell may be selectively turned on or off based on an image, according to image signals, to be displayed during a subsequent display period. More particularly, each discharge cell may be selectively turned on or off based on wall charges formed at corresponding scan and address electrodes using discharge between the scan and address electrodes.

During the sustain period, a sustain voltage is applied to the scan and address electrodes so as to maintain sustain discharge only in the discharge cells selected to be turned on during the address period.

During a driving process of the plasma display device, the address period is usually longer than the sustain period of the sub-field. Brightness of the plasma display device is proportional to the sustain period. Thus, in general, the longer the address period, the shorter the sustain period, such that the brightness of the plasma display device may be decreased. Further, when the plasma display device is driven to display images in high resolution, the number of scan electrodes is increased. In such cases, the address period may be longer as it generally takes a longer period of time to address the discharge cells. More particularly, if the discharge sustain period is reduced, brightness of the plasma display device may be significantly decreased.

That is, most of time of a sub-field may be used for the reset and address periods for wall charge formation and next discharge, not for the sustain period of the sub-field, i.e., not for image display. As a result, brightness is decreased because the discharge time of the plasma display device may be short relative to the time of the sub-field.

Recently, in an attempt to improve brightness, a method of generating priming discharge between the scan and sustain electrodes has been developed. According to this method, address discharge may be generated in high speed by a priming effect of space charge generated through a priming discharge. Thus, the address period may be shortened and the brightness can be also improved.

However, when the priming discharge is generated, visible light caused by the priming discharge may be emitted through emitting cells. As a result, grayscale display is restricted by the increase of much background light.

A high-speed driving method for driving a Y-X-X-Y electrode structure having a priming electrode between X-X electrodes has also been proposed. A priming pulse may be applied to the priming electrode so as to generate a priming discharge. However, according to the above described method, space is required to insert one priming electrode per two emitting cells. The method may be driven in high-speed, relatively, because one priming electrode is inserted between every two discharge cells. However, this method is not suitable for high resolution displays.

### SUMMARY

Embodiments are therefore directed to a plasma display device and a driving method thereof, which substantially overcome one or more of the problems due to the limitations and disadvantages of the related art.

It is therefore a feature of an embodiment to provide a plasma display device and a driving method thereof that may easily perform high-speed driving by reducing a time required to address each discharge cell and/or may improve contrast by addressing each discharge cell using an address discharge weaker than a conventional address discharge.

It is therefore another feature of an embodiment to provide a plasma display device and/or driving method thereof that employs adjacent scan electrodes on opposing sides of a discharge space between adjacent rows of discharge cells to generate priming discharge in order to reduce a time required for performing address discharge of the discharge cells.

At least one of the above and other features and advantages of an embodiments may be realized by providing a plasma display device, including a scan driver adapted to apply reset, scan and sustain signals to scan electrodes, a sustain driver adapted to apply a sustain signal to sustain electrodes, and a display panel including discharge cells and discharge spaces, wherein the discharge cells are partitioned by horizontal and vertical barrier ribs on the display panel, on adjacent ones of the discharge cells, corresponding ones of the scan and sustain electrodes are alternately arranged in one of a scan-sustain-sustain-scan electrode and a sustain-scan-scan-sustain electrode manner, the discharge spaces are between the horizontal barrier ribs of two adjacent rows of the discharge cells, and adjacent ones of the scan electrodes are electrically connected in parallel, and spaced apart from each other in a region above the respective discharge space.

The scan driver may be adapted to apply different reset signals to the scan electrodes of a first row and a second row of the discharge cells, the first row may be adjacent to the second row.

The reset signal may include a rising ramp signal rising with a slope, a falling ramp signal falling with a slope from a peak value of the rising ramp signal, and a priming discharge signal applying positive and negative signals alternately to a first group and a second group of the scan electrodes, the first group of the scan electrodes including the scan electrodes associated with odd numbered rows of the discharge cells and the second group of the scan electrodes including the scan electrodes associated with even numbered rows of the discharge cells.

The priming discharge signal may simultaneously apply a positive signal to the scan electrodes of the first group and a negative signal to the scan electrodes of the second group, and then, simultaneously apply the negative signal to the scan electrodes of the first group and a positive signal to the scan electrodes of the second group.

The positive signal may have a same value as a peak value of the sustain signal.

The sustain driver may be adapted to apply a ground voltage to at least one of the sustain electrodes while the scan driver applies the priming discharge signal to the scan electrode adjacent thereto.

The scan driver may be adapted to generate a priming discharge between the adjacent ones of the scan electrodes by applying a scan signal to one of the adjacent scan electrodes.

The scan signal may have a lower limit value that is lower than a lower limit value of the reset signal.

A gap between the adjacent ones of the scan electrodes may be narrower than a gap between the scan and sustain electrodes.

During an address period, the sustain electrodes may maintain a positive voltage and generate priming discharge between corresponding ones the scan and sustain electrodes.

The scan electrodes may include a sustain electrode extending in a direction parallel to the vertical barrier rib, and the sustain electrodes of adjacent ones of the scan electrodes may be arranged so as to face and be spaced apart from each other in a region above the discharge space.

The sustain electrodes may include a sustain electrode extending in a direction parallel to the vertical barrier rib, and the sustain electrodes of adjacent ones of the sustain electrodes may be connected to each other in a region above the discharge space.

The adjacent ones of the scan electrodes may include one of the scan electrodes associated with an odd numbered row of the discharge cells and one of the scan electrodes associated with an even numbered row of the discharge cells, and the adjacent ones of the scan electrodes may face each other so as to be free of other scan, sustain, or discharge electrodes therebetween.

The display device may further include a light shielding member covering the discharge spaces.

At least one of the above and other features and advantages of an embodiments may be realized by providing a method of driving a plasma display device including a display panel having a plurality of scan electrodes, a plurality of sustain electrodes, a plurality of discharge cells and a plurality of discharge spaces, the method including applying a rising ramp signal rising with a slope to the scan electrodes, applying a falling ramp signal falling with a slope from a peak value of the rising ramp signal to the scan electrodes, and generating priming discharge in the discharge spaces between adjacent ones of the scan electrodes, wherein the discharge cells are partitioned by horizontal and vertical barrier ribs on the display panel, on adjacent ones of the discharge cells, corresponding ones of the scan and sustain electrodes are alternatively arranged in a scan-sustain-sustain-scan electrode or a sustain-scan-scan-sustain electrode manner, the discharge spaces are between the horizontal barrier ribs of two adjacent rows of the discharge cells, and adjacent ones of the scan electrodes are electrically connected in parallel, and spaced apart from each other in a region above the respective discharge space.

Generating priming discharge may include alternately applying positive and negative signals to a first group and a second group of the scan electrodes, the first group of the scan electrodes may include the scan electrodes associated with odd numbered rows of the discharge cells and the second group of the scan electrodes may include the scan electrodes associated with even numbered rows of the discharge cells, wherein the negative signal may have a magnitude equal to or less than a magnitude of a lower limit of the falling ramp signal.

Generating priming discharge may include simultaneously applying the positive signal to the scan electrodes of the first group and the negative signal to the scan electrodes of the second group, and then, simultaneously applying the negative signal to the scan electrodes of the first group and the positive signal to the scan electrodes of the second group.

In generating priming discharge, the positive signal may have a magnitude equal to or less than a magnitude of a peak value of the sustain signal.

Generating priming discharge may include sequentially applying a negative scan signal to the scan electrodes to sequentially generate priming discharge above the respective discharge space between the adjacent scan electrodes.

The negative scan signal may have a magnitude greater than a magnitude of a lower limit of the falling ramp signal.

The method may include alternately applying a sustain signal to the scan and sustain electrodes.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a schematic diagram of an exemplary embodiment of a plasma display device;

FIG. 2 illustrates a schematic diagram of an exemplary embodiment of a display panel employable in the plasma display device of FIG. 1;

FIG. 3 illustrates a waveform diagram of exemplary driving signals according to one exemplary method of driving the plasma display device of FIG. 1;

FIG. 4 illustrates a waveform diagram of exemplary driving signals according to another exemplary method of driving the plasma display device of FIG. 1; and

FIG. 5 illustrates a waveform diagram of exemplary driving signals according to another exemplary method of driving the plasma display device.

### DETAILED DESCRIPTION OF EMBODIMENTS

Korean Patent Application No. 10-2008-0046530, filed on May 20, 2008, in the Korean Intellectual Property Office, and entitled: “Plasma Display Device and Driving Method Thereof,” is incorporated by reference herein in its entirety.

Exemplary embodiments will now be described more fully hereinafter with reference to the accompanying drawings, in which exemplary embodiments are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art. Further, some of the elements that are not essential to the complete understanding of embodiments of the invention are omitted for clarity. Also, like reference numerals refer to like elements throughout the specification.

Further, in the drawing figures, the dimensions of elements and regions may be exaggerated for clarity of illustration. It will also be understood that when an element is referred to as being “on” another element, it may be directly on the other element, or intervening elements may also be present. Further, it will be understood that when an element is referred to as being “under” another element, it may be directly under, and one or more intervening elements may also be present. In addition, it will also be understood that when an element is referred to as being “between” two elements, it may be the only element between the two elements, or one or more intervening elements may also be present.

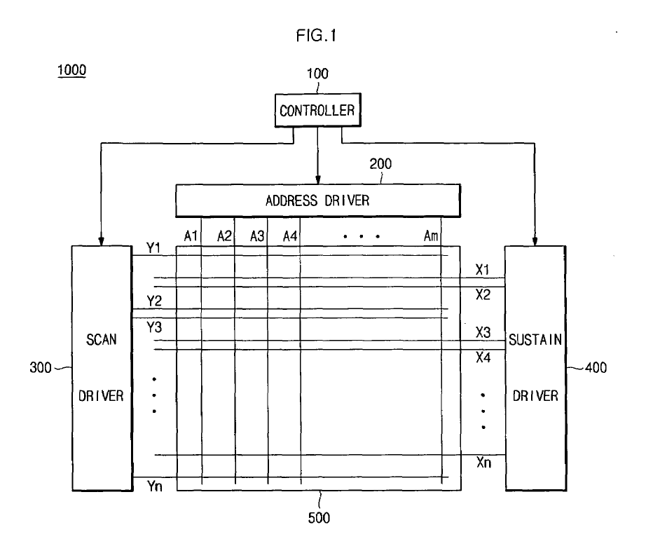

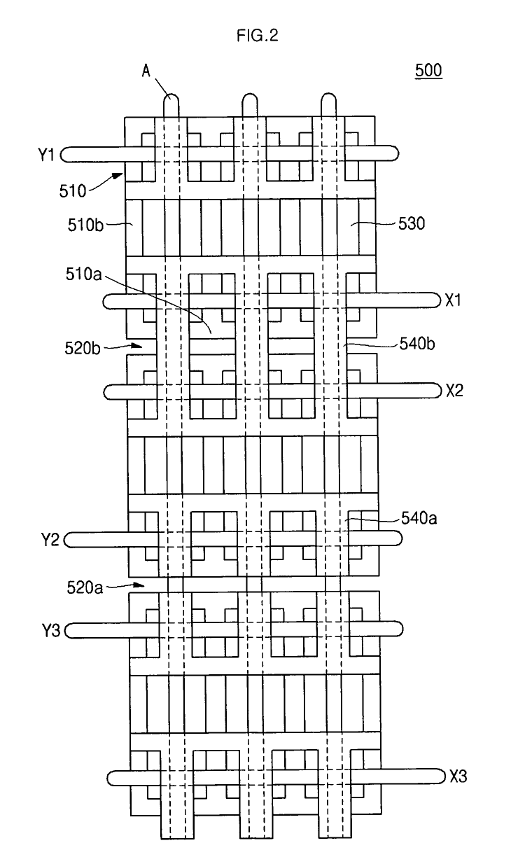

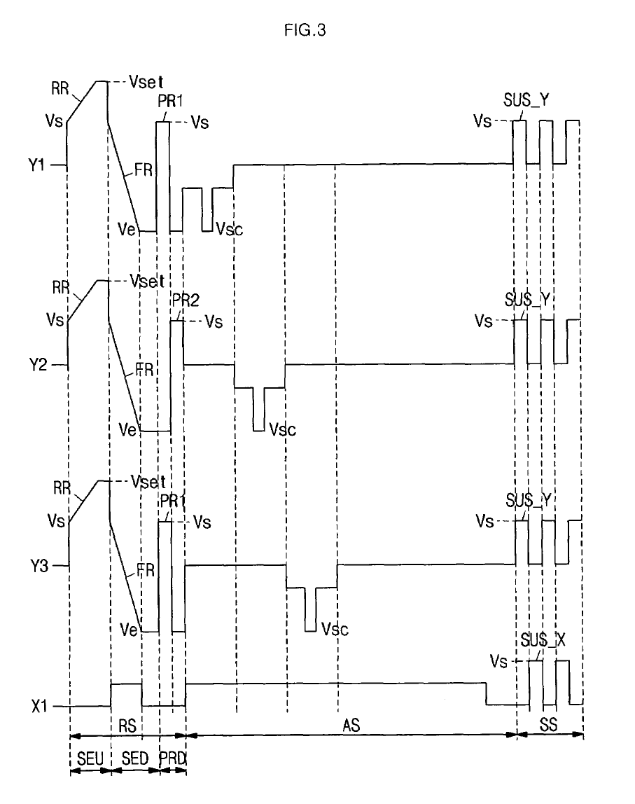

FIG. 1 illustrates a schematic diagram of an exemplary embodiment of a plasma display device 1000. FIG. 2 illustrates a schematic diagram of an exemplary embodiment of a display panel 500 employable in the plasma display device 1000 of FIG. 1. FIG. 3 illustrates a waveform diagram of exemplary driving signals according to one exemplary method of driving the plasma display device 1000 of FIG. 1.

In the accompanying figures and description, exemplary waveforms that may be applied to three scan electrodes, e.g., Y1, Y2, Y3, and an exemplary waveform that may be applied to a sustain electrode X1 are specifically illustrated and/or described. In embodiments, it should be understood that features of the exemplary waveforms may be applied, e.g., to one, some, or all scan electrodes Y1 to Yn, or to one, some, or all sustain electrodes X1 to Xn. More particularly, e.g., the exemplary waveform for the sustain electrode X1 may be applied to all the sustain electrodes X1 to Xn.

Referring to FIGS. 1 to 3, the plasma display device 1000 may include the controller 100, an address driver 200, a scan driver 300, a sustain driver 400 and the display panel 500.

The controller 100 may convert an image signal transmitted from an image processor (not shown) or an external device into a data signal that may be processed by the address driver 200, the scan driver 300 and the sustain driver 400. Particularly, the controller 100 may apply a control signal to the scan driver 300, and may thereby control the scan driver 300 to output different reset signals during reset periods.

The address driver 200 may supply an address signal to an address electrode of the display panel 500 according to a data signal input from the address driver 200.

The scan driver 300 may supply a reset signal (reset pulse), a scan signal (scan pulse) and a sustain signal (sustain pulse) to the scan electrodes Y1 to Yn based on a control signal of the controller 100. The scan electrodes Y1 to Yn may be formed on the display panel 500.

Referring to FIGS. 1 and 3, during a reset period RS, the scan driver 300 may apply a reset signal including a rising ramp signal RR, a falling ramp signal FR and a priming discharge signal PR to the scan electrodes Y1 to Yn. Referring to FIG. 3, in embodiments, e.g., the scan driver 300 may apply the same rising ramp signal RR and falling ramp signal FR to all scan electrodes Y1 to Yn and may apply different priming discharge signals PR to different groups of the scan electrodes Y1 to Yn. For example, the scan driver 300 may group the scan electrodes Y1 to Yn into two groups, e.g., odd and even rows, and may apply a first priming discharge signal PR1 having a first polarity to the first group, e.g., odd rows, and a second priming discharge signal PR2 having a different polarity to the second group, e.g., even rows. In embodiments, e.g., the scan driver 300 may alternately supply the different priming discharge signals PR to the scan electrodes Y1 to Yn.

More particularly, e.g., the first priming discharge signal PR1 may have an opposite polarity to the second priming discharge signals PR2 and the first and second priming discharge signals PR1, PR2 may be applied to respective adjacent pairs of the scan electrodes, e.g., Y1 and Y2, Y2 and Y3, etc. Priming discharge may occur between the scan electrodes Y1 to Yn arranged to form a pair in adjacent discharge cells. Thus, brightness may be improved because a subsequent address period may be shortened. An exemplary waveform of the priming discharge signal PR and the priming discharge process will be explained below.

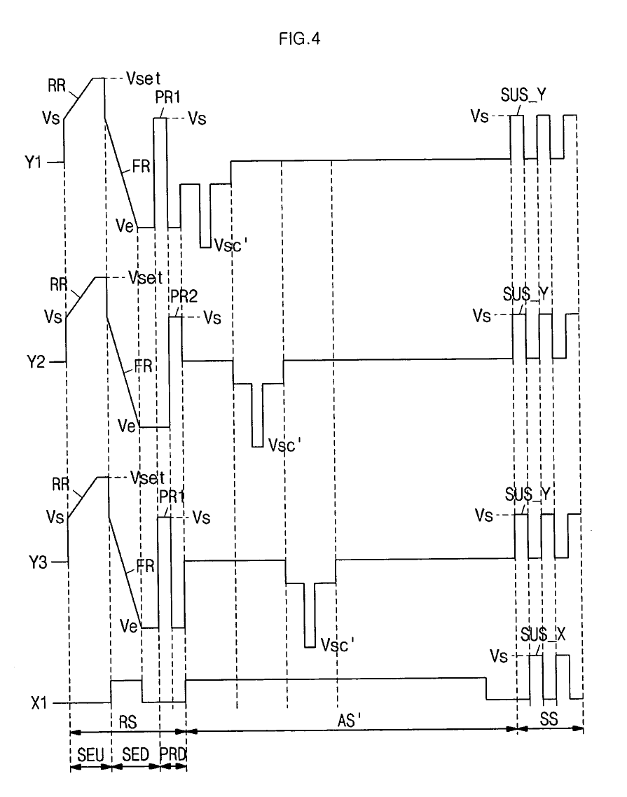

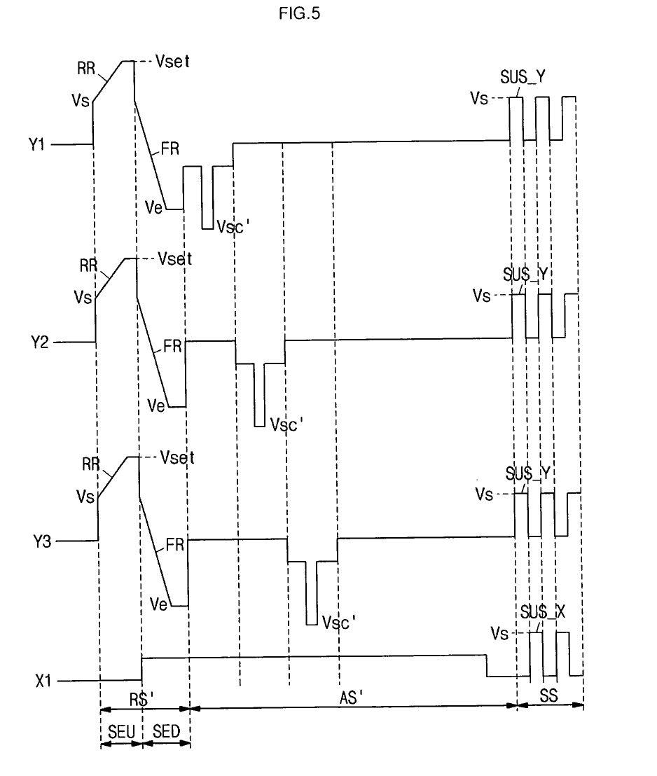

Referring to FIGS. 1 and 3, during an address period AS, the scan driver 300 may apply the respective scan signal to the scan electrodes Y1 to Yn. A lower limit value Vsc of the scan signal may be lower than that of the falling ramp signal FR. In addition, when the lower limit value Vsc of the scan signal is sufficiently low (e.g., Vsc′ in FIGS. 4 and 5), an additional priming discharge may occur between the adjacent scan electrodes during the address period AS, respectively. The priming discharge process during the address period AS will be explained below.

During a sustain period SS, the scan driver 300 may apply a same type of sustain signal SUS_Y to all scan electrodes Y1 to Yn. The sustain signal SUS_Y may have a type of periodically repeated square wave.

During the sustain period SS, the sustain driver 400 may apply a sustain signal SUS_X to sustain electrodes X1 to Xn. The sustain signal SUS_X may be a square wave signal complementary to the sustain signal SUS_Y applied to the scan electrodes Y1 to Yn.

In embodiments, the sustain driver 400 may apply a square waveform to the sustain electrodes X1 to Xn during the reset period RS and/or address period AS.

Referring to FIG. 2, the display panel 500 may have a double barrier rib structure. For example, the display panel 500 may include discharge cells 510 partitioned by first barrier ribs, e.g., horizontal barrier ribs 510a and second barrier ribs, e.g., vertical barrier ribs 510b. Discharge spaces 520a, 520b partitioned by the horizontal barrier ribs 510a may be provided between adjacent ones of the discharge cells 510.

The display panel 500 may include a plurality of address electrodes A1 to Am, phosphor layers (not shown), scan electrodes Y1 to Yn, sustain electrodes X1 to Xn and sustain electrodes 540a, 540b.

The address electrodes A1 to Am may extend in a first direction, e.g., a vertical direction, e.g., a length direction of the vertical barrier rib 510b in FIG. 2. The address electrodes A may extend below each discharge cell 510.

Phosphor layers (not shown) may be coated in regions defined by the horizontal barrier ribs 510a and vertical barrier ribs 510b, the scan electrodes Y1 to Yn, sustain electrodes X1 to Xn.

The scan electrodes Y1 to Yn and the sustain electrodes X1 to Xn may extend along a second direction, e.g., a horizontal direction, e.g., a length direction of the horizontal barrier rib 510a in FIG. 2. The scan electrodes Y1 to Yn and the sustain electrodes X1 to Xn may extend parallel to each other. The scan electrodes Y1 to Yn and the sustain electrodes X1 to Xn may extend above, e.g., directly above, the discharge cells 510. Each of the discharge cells 510 may be associated with one of the scan electrodes Y1 to Yn and one of the sustain electrodes X1 to Xn.

More particularly, in embodiments, e.g., each of the discharge cells 510 may overlap with at least a portion of one of the scan electrodes Y1 to Yn and at least a portion of one of the sustain electrodes X1 to Xn. The scan electrodes Y1 to Yn and the sustain electrodes X1 to Xn may be alternatively arranged relative to adjacent ones of the discharge cells 510. For example, in embodiments, the scan electrodes Y1 to Yn and the sustain electrodes X1 to Xn may be arranged, e.g., in a scan electrode-sustain electrode-sustain electrode-scan electrode (Y-X-X-Y) repeating pattern or a sustain electrode-scan electrode-scan electrode-sustain electrode (X-Y-Y-X) repeating pattern.

In embodiments, the sustain electrodes 540a may at least partially overlap the respective scan electrodes Y1 to Yn and/or the respective address electrodes A1 to Am. The sustain electrodes 540a may be connected to the respective scan electrodes Y1 to Yn. The sustain electrodes 540b may at least partially overlap the respective sustain electrodes X1 to Xn and/or the respective address electrodes A1 to Am. The sustain electrodes 540b may be connected to the respective sustain electrodes X1 to Xn. More particularly, e.g., portions of the sustain electrodes 540a, 540b may extend substantially parallel to the respective sustain electrodes X1 to Xn and/or scan electrodes Y1 to Yn and, relative to the respective sustain electrodes X1 to Xn and/or scan electrodes Y1 to Yn may overlap a portion of the respective discharge cell 510 closer to a center of the discharge cell 510.

More particularly, referring to FIG. 2, sustain electrodes 540a may extend inside the discharge cells 510 from the respective scan electrode Y1 to Yn and/or outward toward the respective horizontal barrier rib 510a. A space defined by opposing horizontal barrier ribs 510a and/or opposing vertical barrier ribs 510b of the discharge cell 510 may be considered as inside the respective discharge cell 510. In embodiments, e.g., relative to the respective scan electrode Y1 to Yn, the sustain electrodes 540a may include a portion extending further inside the respective discharge cell 510 than the scan electrode Y1 to Yn.

The sustain electrodes 540a corresponding to adjacent discharge cells 510 along the second direction, e.g., horizontal direction, may be commonly connected via a portion of the sustain electrodes 540a extending across a horizontal width of the respective adjacent discharge cells 510. More particularly, e.g., the sustain electrodes 540a may include a first portion extending, e.g., parallel to the respective scan electrode Y1 to Yn, across the respective discharge cell 510 and a second portion extending over the respective scan electrode Y1 to Yn out toward the respective horizontal barrier rib 510a. Referring to FIG. 2, e.g., the sustain electrodes 540a may extend toward a respective edge of the corresponding horizontal barrier rib 510a, e.g., an end portion of the sustain electrode 540 may be aligned and/or substantially aligned with the horizontal barrier rib 510a, e.g., an outer edge of the horizontal barrier rib 510a.

That is, e.g., in embodiments, the sustain electrodes 540a may correspond to comb-like structures having a grip portion extending across inside portions of adjacent ones of the discharge cells 510 along the horizontal direction and a plurality of prongs extending outward towards the corresponding horizontal barrier rib 510a overlapping the respective scan electrode Y1 to Yn and each of the adjacent ones of the discharge cells 510.

Adjacent ones of the sustain electrodes 540a may be spaced apart from each other. For example, in the embodiment illustrated in FIG. 2, adjacent ones of the sustain electrodes 540a are spaced so as to be separate from each other by a width of the discharge space 520a along the first direction, e.g., vertical direction. More particularly, in the exemplary embodiment of FIG. 2, the sustain electrode 540a corresponding to the scan electrode Y2 is spaced apart from the adjacent sustain electrode 540a corresponding to the scan electrode Y3 by, e.g., the discharge space 520a. More particularly, in embodiments, the sustain electrode 540a corresponding to the scan electrode Y2 may be spaced apart from the adjacent sustain electrode 540a corresponding to the scan electrode Y3 in a region above the discharge space 520a. The sustain electrodes 540a may be electrically separate from each other. Thus, different electrical signals may be respectively applied to, e.g., adjacent ones of the sustain electrodes 540a.

Sustain electrodes 540b may extend inside the respective discharge cell 510 from the respective sustain electrode X1 to Xn and/or outward toward the adjacent discharge cell 510. In embodiments, the sustain electrodes 540b may be grouped together, e.g., in pairs. In such embodiments, e.g., one end of the sustain electrodes 540a may extend inward from the respective sustain electrode X1 to Xn and a second end may extend outward and be connected to the corresponding adjacent sustain electrode 540b. Referring to FIG. 2, the sustain electrodes 540b may cross the respective discharge spaces 520b along, e.g., an upper portion of the respective discharge space 520b.

In embodiments, the sustain electrodes 540b may have a shape substantially similar to a shape, e.g., comb-like structure, of the sustain electrodes 540a. That is, e.g., a pair of the sustain electrodes 540b corresponding to adjacent ones of the discharge cells 510 may have substantially a same shape as the corresponding sustain electrodes 540a, but may be connected over the respective discharge space 520b. As described above, the sustain electrodes 540b of corresponding adjacent ones of the discharge cells 510 may be sandwiched between the sustain electrodes 540a of the respective adjacent discharge cells 510.

In embodiments, e.g., a common electrical signal may be applied to the sustain electrodes X1 to Xn. Thus, the adjacent sustain electrodes 540b may be electrically coupled to each other.

Upper and lower parts of the display panel 500 may be covered by glass (not shown). A dielectric layer (not shown) may be further formed between the address electrode A1 to Am and phosphor layer (not shown). More particularly, e.g., an upper dielectric layer (not shown) and a protection layer (not shown) may be formed below the scan electrodes Y1 to Yn, sustain electrodes X1 to Xn and sustain electrodes 540a and 540b.

As described above, the plasma display device 1000 may include discharge spaces 520a, 520b between adjacent discharge cells 510, and the scan electrodes Y1 to Yn and sustain electrodes X1 to Xn associated with the corresponding adjacent ones of the discharge cells 510 may be alternately arranged in a Y-X-X-Y or X-Y-Y-X manner over the adjacent discharge cells 510. In addition, the sustain electrodes 540b associated with corresponding adjacent ones of the discharge cells 510 may be connected to the respective sustain electrode X1 to Xn and to each other over the respective discharge space 520b. The sustain electrodes 540a associated with corresponding adjacent ones of the discharge cells 510 may be connected to the respective scan electrode Y1 to Yn, spaced apart from each other and may face each other across the respective discharge space 520a. As described above, the corresponding adjacent pairs of the sustain electrodes 540a connected to the respective pair of the scan electrodes Y1 to Yn may perform priming discharge in the discharge spaces 520a.

An exemplary driving operation of the plasma display device 1000 will be explained below with reference to the exemplary driving signals of FIG. 3 that may be applied to the plasma display device 1000 of FIG. 1.

Referring to FIG. 3, the exemplary waveform diagram includes a reset period RS for initializing the discharge cells, an address period AS for selecting the discharge cells to be turned on, and a sustain period SS for performing a display discharge.

The reset period RS may include a set-up period SEU, a set-down period SED and a priming discharge period PRD.

During the set-up period SEU, a rising ramp signal RR may be applied to the scan electrodes Y1 to Yn, e.g., Y1 to Y3 in FIG. 3. During the set-up period SEU, a voltage of the scan electrodes Y1 to Y3 may be gradually increased to a peak voltage Vset, and the sustain electrodes X1 to Xn, e.g., X1 in FIG. 3, may be set at a ground level. Accordingly, negative wall charges may be formed below the scan electrodes Y1 to Y3, and positive wall charges may be formed below the sustain electrode X1.

During the set-down period SED, a falling ramp signal FR may be applied to the scan electrodes Y1 to Y3. During the set-down period SED, the voltage of the scan electrodes Y1 to Y3 may be gradually decreased to a negative erase voltage Ve, and a positive voltage may be applied to the sustain electrode X1. However, in embodiments, e.g., the sustain electrode X may be kept at the ground voltage during this time, i.e., the positive voltage may not be applied to the sustain electrode X1 in some cases. During the set-down period SED, a predetermined amount of the wall charge may be erased by the falling ramp signal FR. Thus, the electrodes may be changed to a proper condition for addressing.

During the priming discharge period PRD, a priming discharge signal PR may be applied to the scan electrodes Y1 to Y3. More particularly, different priming discharge signals, e.g., PR1, PR2, may be respectively applied to the different groups, e.g., odd and even rows, of the scan electrodes Y1 to Y3. For example, the scan electrodes Y1 and Y3 of odd number rows may be included in the first group to which the first priming discharge signal PR1 may be applied and the scan electrode Y2 of an even number row may be included in the second group to which the second priming discharge signal PR2 may be applied. The first priming discharge signal PR1 may have an opposite polarity to the second priming discharge signals PR2.

More particularly, referring to FIG. 3, during the priming discharge period PRD, first a positive sustain voltage Vs may be applied to the scan electrodes, e.g., Y1 and Y3, of odd number rows, and the negative erase voltage Ve may be applied to the scan electrodes, e.g., Y2, of even number rows. Next, the negative erase voltage Ve may be applied to the scan electrodes of odd number rows, e.g., Y1 and Y3, and the positive sustain voltage Vs may be applied to the scan electrodes, e.g., Y2, of even number rows. As a result, priming discharge may occur between the adjacent scan electrodes during the priming discharge period PRD.

Priming discharge may be generated in the discharge spaces 520 of the display panel 500. More particularly, referring to FIGS. 1 to 3, the priming discharge may be generated, e.g., between the scan electrode Y2 of the second row and the scan electrode Y3 of the third row, e.g., in the discharge space 520a between adjacent scan electrodes in the same pattern as that as described above (not shown). In embodiments, a light shielding member (not shown) may be provided above the discharge spaces 520 for preventing and/or reducing background light from the priming discharge.

A gap between adjacent ones of the scan electrodes Y1 to Y3 and the sustain electrodes X1 to Xn may be wider than a gap between the adjacent ones of the scan electrodes Y1 to Y3. More particularly, in some embodiments, a gap between adjacent ones of the scan electrodes Y1 to Y3 and the sustain electrodes X1 to Xn may be much wider than a gap between the adjacent ones of the scan electrodes Y1 to Y3. During the priming discharge period PRD, a voltage of the sustain electrode X1 to Xn may be set at the ground voltage. Thus, a voltage difference between adjacent ones of the scan electrodes Y1 to Yn and the sustain electrodes X1 to Xn is less than a voltage difference between adjacent corresponding ones of the scan electrodes Y1 to Yn, e.g., one of the scan electrodes, e.g., Y1, Y3, of the odd number rows and the corresponding adjacent one of the scan electrodes, e.g., Y2, Y4, of the even number rows. Accordingly, a discharge between the scan electrodes Y1 to Yn and the sustain electrodes X1 to Xn may never and/or very rarely occur. Thus, little and/or no background light may be generated as a result a discharge between the scan electrodes Y1 to Yn and the sustain electrodes X1 to Xn.

More particularly, priming particles may be generated by the priming discharges generated between the adjacent corresponding ones of the scan electrodes of the different groups, e.g., one of the scan electrodes, e.g., Y1, Y3, of the odd number rows and the corresponding adjacent one of the scan electrodes, e.g., Y2, Y4, of the even number rows. When a high-frequency voltage is applied during a subsequent address period AS, the priming particles may vibrate and may continuously ionize discharge gas. As a result, the priming particles may support address discharge and address discharge delay time may be reduced. As a result of a reduction in the address period AS, brightness of the display may be increased because a time of the sustain period SS may be increased and/or a high-resolution display may be realized because an additional priming electrode occupying additional area between the electrodes is not required.

During the address period AS, the scan signal may be sequentially applied to the scan electrodes, e.g., Y1 to Y3, and the respective address signals may be simultaneously applied to the address electrodes A1 to Am (not shown). During the address period AS, wall charges may be established by the discharge resulting from corresponding scan signal and address signal supplied to the scan electrode Y and address electrode A associated with each the discharge cells 510 in which the display discharge is to be performed during the subsequent sustain period SS.

Additional priming discharge may be generated between the scan electrodes Y1 to Yn and the sustain electrodes X1 to Xn because the sustain electrodes X1 to Xn may maintain positive voltages during the address period AS. As discussed above, such additional priming discharge may be relatively weak because the gap between the scan electrodes Y1 to Yn and the sustain electrodes X1 to Xn may be wider than the gap between the scan electrodes of the first group, e.g., Y1 and Y3 of odd number rows and the scan electrodes Y2 and Y4 of even number rows.

In embodiments, as a result of the priming discharge, light emission during the address period AS may be reduced because addressing may be performed using an address discharge weaker than an address discharge of a conventional structure. That is, in embodiments, as a result of the priming discharge, an address discharge weaker than conventional address discharge may be employed to selectively address the discharge cells 510. Thus, high speed driving may be possible and image contrast may be improved.

During the sustain period SS, sustain signals SUS_Y and SUS_X may be alternatively applied to the scan electrodes Y1 to Yn and the sustain electrodes X1 to Xn, respectively. Display discharge may be generated by every sustain signal SUS_Y, SUS_X in the discharge cells selected by the address discharge during the previous address period AS, and may thereby allow images to be displayed.

In some embodiments, the sustain signal SUS_Y, SUS_X may be alternatively supplied to only one electrode of the scan electrode Y1 to Yn or sustain electrode X1 to Xn (not shown). That is, e.g., display discharge may be performed by applying a sustain signal that is alternately changed between the positive sustain voltage Vs and the negative sustain voltage −Vs to either the scan electrodes Y1 to Yn or the sustain electrodes X1 to Xn.

The plasma display device 1000 may generate priming discharge between adjacent scan electrodes Y1 to Yn in the discharge space 520a by applying different priming discharge signals PR respectively to the scan electrodes Y1 to Yn of the different groups, e.g., between the scan electrodes, e.g., Y1, Y3, of the odd number rows and the scan electrodes, e.g., Y2, Y4, of the even number rows during the reset period RS. In embodiments, light that may result from such priming discharge may not be displayed in the pixels and may not affect background light. Thus, embodiments employing such priming discharge may display a full range of grayscale by the pixels, i.e., grayscale display may not be restricted as a result of visible light emitted during priming discharge.

As discussed above, in embodiments, an additional weak priming discharge may be generated between the scan electrodes Y1 to Yn and the sustain electrodes X1 to Xn during the address period AS.

In embodiments, priming particles generated by priming discharge may reduce an address discharge delay time for achieving address discharge during the address period AS. As a result, image brightness may be increased because the sustain period SS may be increased, relatively, as a result of any reduction of the address period AS during one sub-frame.

In embodiments, image contrast may be improved by reducing an address discharge delay time compared to known conventional devices. Thus, embodiments may enable an improved high-resolution display to be realized because an additional priming electrode need not be included.

FIG. 4 illustrates a waveform diagram of exemplary driving signals according to another exemplary method of driving the plasma display device 1000 of FIG. 1. The same drawing reference numerals are used for the same elements across various figures. In general, only differences between the exemplary embodiment of FIG. 3 and the exemplary embodiment of FIG. 4 will be described below.

In comparison to the exemplary waveform of FIG. 3, according to the exemplary waveform employable of FIG. 4, during an address period AS′, a scan voltage Vsc′ may be sequentially supplied to the scan electrodes Y1 to Y3. The scan voltage Vsc′ is lower than the scan voltage Vsc of the exemplary waveform of FIG. 3, and set sufficiently low so as to generate a priming discharge between the adjacent scan electrodes Y1 to Yn. A range of values of the scan voltage Vsc′ will be apparent to those of ordinary skill in the art. Therefore, detailed explanation will be omitted.

When the scan voltage Vsc′ is applied during the address period AS′, a voltage difference may be generated between the adjacent scan electrodes Y1 to Yn, e.g., between Y2 and Y3, thereby causing priming discharge.

Priming discharge may have a same and/or substantially same effect as that of a reset period of known methods, except that, in embodiments, priming discharge may be sequentially generated according to an order in which the scan signals are applied.

As described above, embodiments of the plasma display device 1000 may generate priming discharge during the address period AS, AS′ and the reset period RS. By reducing the address period AS, AS′ as described above, brightness and/or contrast may be improved by high-speed driving. Thus, embodiments may enable a high-resolution display to be realized without requiring additional elements.

FIG. 5 illustrates a waveform diagram of exemplary driving signals according to another exemplary method of driving the plasma display device 1000 of FIG. 1. The same drawing reference numerals are used for the same elements across various figures. In general, only differences between the exemplary embodiment of FIG. 4 and the exemplary embodiment of FIG. 5 will be described below.

In comparison to the exemplary waveforms of FIGS. 3 and 4, according to the exemplary waveform of FIG. 5, a reset period RS′ does not include a priming discharge period PRD. According to the exemplary waveform of FIG. 5, the scan voltage Vsc′ may be applied during the address period AS′. As described above with regard to FIG. 4, a priming discharge can be generated during the address period AS′ by applying the changed scan voltage Vsc′. Accordingly, in such embodiments, priming discharge may be generated only during the address period AS′. Thus, in embodiments, priming discharge may be generated by separately connecting a voltage source to be employed during the address period AS′, without requiring additional elements.

As described above, in embodiments, the plasma display device 1000 may generate priming discharge only during the address period AS′. Accordingly, by reducing a time of the address period without using additional elements, embodiments may enable a high-resolution display to be realized. Embodiments may enable a plasma display device having improved image brightness and/or image contrast to be realized.

Embodiments may provide a plasma display device and a driving method thereof that may more easily perform high-speed driving by employing a reduced amount of time to address each discharge cell as compared to known devices and driving methods.

Embodiments may separately provide a plasma display device and a driving method thereof that may employ a weaker address discharge than known devices and driving methods, and may thereby improve image contrast by addressing each discharge cell only by address discharge weaker than the conventional address discharge. By reducing a time of an address period, embodiments may enable a time of a sustain period to be increased, and may thereby improve, e.g., image brightness, image contrast, grayscale capability and/or resolution of the display.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the invention as set forth in the following claims.

What is claimed is:

1. A plasma display device, comprising:
a scan driver adapted to apply reset, scan, and sustain signals to scan electrodes,
a sustain driver adapted to apply a sustain signal to sustain electrodes; and
a display panel including discharge cells and discharge spaces, wherein:
the discharge cells are partitioned by horizontal and vertical barrier ribs on the display panel,
on adjacent ones of the discharge cells, corresponding ones of the scan and sustain electrodes are alternately arranged in one of a scan-sustain-sustain-scan electrode and a sustain-scan-scan-sustain electrode manner,
the discharge spaces are between the horizontal barrier ribs of two adjacent rows of the discharge cells, and
adjacent ones of the scan electrodes are electrically connected in parallel, and spaced apart from each other in a region above the respective discharge space.

2. The plasma display device as claimed in claim 1, wherein the scan driver is adapted to apply different reset signals to the scan electrodes of a first row and a second row of the discharge cells, the first row being adjacent to the second row.

3. The plasma display device as claimed in claim 1, wherein the reset signal comprises:
a rising ramp signal rising with a slope,
a falling ramp signal falling with a slope from a peak value of the rising ramp signal, and
a priming discharge signal applying positive and negative signals alternately to a first group and a second group of the scan electrodes, the first group of the scan electrodes including the scan electrodes associated with odd numbered rows of the discharge cells and the second group of the scan electrodes including the scan electrodes associated with even numbered rows of the discharge cells.

4. The plasma display device as claimed in claim 3, wherein:
the priming discharge signal simultaneously applies the positive signal to the scan electrodes of the first group and the negative signal to the scan electrodes of the second group, and then, simultaneously applies a negative signal to the scan electrodes of the first group and a positive signal to the scan electrodes of the second group.

5. The plasma display device as claimed in claim 3, wherein the positive signal has a same value as a peak value of the sustain signal.

6. The plasma display device as claimed in claim 1, wherein the sustain driver is adapted to apply a ground voltage to at least one of the sustain electrodes while the scan driver applies the priming discharge signal to the scan electrode adjacent thereto.

7. The plasma display device as claimed in claim 1, wherein the scan driver is adapted to generate a priming discharge between the adjacent ones of the scan electrodes by applying a scan signal to one of the adjacent scan electrodes.

8. The plasma display device as claimed in claim 7, wherein the scan signal has a lower limit value that is lower than a lower limit value of the reset signal.

9. The plasma display device as claimed in claim 1, wherein a gap between the adjacent ones of the scan electrodes is narrower than a gap between the scan and sustain electrodes.

10. The plasma display device as claimed in claim 1, wherein, during an address period, the sustain electrodes maintain a positive voltage and generate priming discharge between corresponding ones the scan and sustain electrodes.

11. The plasma display device as claimed in claim 1, wherein:
the scan electrodes further include a sustain electrode extending in a direction parallel to the vertical barrier rib, and
the sustain electrodes of adjacent ones of the scan electrodes are arranged so as to face and be spaced apart from each other in a region above the discharge space.

12. The plasma display device as claimed in claim 1, wherein:
the sustain electrodes further include a sustain electrode extending in a direction parallel to the vertical barrier rib, and
the sustain electrodes of adjacent ones of the sustain electrodes are connected to each other in a region above the discharge space.

13. The plasma display device as claimed in claim 1, wherein the adjacent ones of the scan electrodes include one of the scan electrodes associated with an odd numbered row of the discharge cells and one of the scan electrodes associated with an even numbered row of the discharge cells, and the adjacent ones of the scan electrodes face each other so as to be free of other scan, sustain, or discharge electrodes therebetween.

14. The plasma display device as claimed in claim 1, further comprising a light shielding member covering the discharge spaces.

15. A method of driving a plasma display device including a display panel having a plurality of scan electrodes, a plurality of sustain electrodes, a plurality of discharge cells and a plurality of discharge spaces, the method comprising:
applying a rising ramp signal rising with a slope to the scan electrodes,
applying a falling ramp signal falling with a slope from a peak value of the rising ramp signal to the scan electrodes, and
generating priming discharge in the discharge spaces between adjacent ones of the scan electrodes, wherein:
the discharge cells are partitioned by horizontal and vertical barrier ribs on the display panel,
on adjacent ones of the discharge cells, corresponding ones of the scan and sustain electrodes are alternatively arranged in a scan-sustain-sustain-scan electrode or a sustain-scan-scan-sustain electrode manner,
the discharge spaces are between the horizontal barrier ribs of two adjacent rows of the discharge cells, and
adjacent ones of the scan electrodes are electrically connected in parallel, and spaced apart from each other in a region above the respective discharge space.

16. The method of driving the plasma display device as claimed in claim 15, wherein generating priming discharge includes alternately applying positive and negative signals to a first group and a second group of the scan electrodes, the first group of the scan electrodes including the scan electrodes associated with odd numbered rows of the discharge cells and the second group of the scan electrodes including the scan electrodes associated with even numbered rows of the discharge cells, wherein the negative signal has a magnitude equal to or less than a magnitude of a lower limit of the falling ramp signal.

17. The method of driving the plasma display device as claimed in claim 16, wherein generating priming discharge includes simultaneously applying the positive signal to the scan electrodes of the first group and the negative signal to the scan electrodes of the second group, and then, simultaneously applying a negative signal to the scan electrodes of the first group and the positive signal to the scan electrodes of the second group.

18. The method of driving the plasma display device as claimed in claim 17, wherein in generating priming discharge, the positive signal has a magnitude equal to or less than a magnitude of a peak value of the sustain signal.

19. The method of driving the plasma display device as claimed in claim 15, wherein generating priming discharge includes sequentially applying a negative scan signal to the scan electrodes to sequentially generate priming discharge above the respective discharge space between the adjacent scan electrodes.

20. The method of driving the plasma display device as claimed in claim 19, wherein the negative scan signal has a magnitude greater than a magnitude of a lower limit of the falling ramp signal.

21. The method of driving the plasma display device as claimed in claim 20, further comprising alternately applying a sustain signal to the scan and sustain electrodes.
